(19) United States
(12) Patent Application Publication
(10) Pub. No.: US 2018/0231667 A1
(43) Pub. Date: Aug. 16, 2018

(54) GNSS-R EARTH SURFACE SURVEY DEVICE AND METHOD

(71) Applicant: Pacific Telecom & Navigation (Shenzhen) Limited, Shenzhen (CN)

(72) Inventor: Lei Ye, Shanghai (CN)

(73) Assignee: Pacific Telecom & Navigation (Shenzhen) Limited, Shenzhen (CN)

(21) Appl. No.: 15/954,107

(22) Filed: Apr. 16, 2018

Related U.S. Application Data
(63) Continuation of application No. PCT/CN2015/094525, filed on Nov. 13, 2015.

(30) Foreign Application Priority Data
Oct. 19, 2015 (CN) 2015106798344

(51) Int. Cl. G01S 19/22; G01S 19/14

(52) U.S. Cl. CPC G01S 19/22; G01S 19/14

(57) ABSTRACT

The present disclosure discloses an GNSS-R earth surface survey device and method. By configuring a GNSS signal receiving antenna capable of receiving signals at respective frequencies corresponding to different GNSS systems, and at the same time, acquiring, during an intermediate frequency extraction stage and through independent channels, direct signals and reflected signals of respective different frequencies so as to obtain digital intermediate frequency signals; selecting, based on a user setting or a signal strength, a GNSS system to be used to process data; and obtaining, by analyzing a Doppler frequency shift and a time delay of the digital intermediate frequency signal, a difference of the GNSS reflected signal with respect to the GNSS direct signal, thereby obtaining earth surface data through inversion on the basis of the same. In this way, the present disclosure enables compatibility with different GNSS system signals at the same time for earth surface survey.

### CROSS-REFERENCE TO RELATED PATENT APPLICATIONS

The present application is a continuation of International Application No. PCT/CN2015/094525, filed Nov. 13, 2015, which claims the benefit of priority to Chinese Application No. CN 2015106798344, filed on Oct. 19, 2015, the content of which is incorporated herein by reference in its entirety.

### FIELD OF THE INVENTION

The present disclosure relates to the field of remote sensing technology, in particular to a GNSS-R earth surface survey device and method.

### BACKGROUND

The development of the Global Navigation Satellite System (GNSS) constellation (GPS in the United States, GLONASS in Russia and BeiDou in China) provides us with an L-band signal source that can scan the globe continuously, extensively and in the full coverage. At any place on the surface of the earth, 10-20 GNSS satellite signals can be received simultaneously now. The concept of GNSS-R (GNSS-Reflection) was first proposed by a French scientist M. Martin-Neira in 1993. It uses global GNSS signals as a remote sensing emission signal source. The ground installation, on one hand, collects navigation broadcast signals, and on the other hand, synchronizes the same source signals of the GNSS generated by the reflection of the signals of GNSS on the surface of the earth for performing a passive mode observation similar to multi-band radar interference. The basic principle is to perform multiple comparative phase analysis on the data produced by orthogonal intersection of the right-handed circularly polarized direct signal and the left-handed circularly polarized reflection signal of the GNSS and use the characteristic that L-band 1575 MHz is sensitive to the boundary between water and other substances (including ice) to capture, collect, analyze, and process the formed planar interference data in real time.

The existing GNSS-R earth surface survey devices mostly adopt omnidirectional antennas for signal collection, and usually require performing baseband decoding on GNSS signals. The GNSS-R technology which performs remote sensing based on reflected signal C/A codes or P(Y) codes needs to decode the signal, which makes the existing technology generally only be capable to perform earth surface survey based on the signals of the GPS system.

### SUMMARY OF THE INVENTION

In view of this, the present disclosure provides a GNSS-R earth surface survey device to be compatible with multiple different GNSS-R system signals to perform earth surface survey.

In a first aspect, the present disclosure provides a GNSS-R earth surface survey device comprising:

a first receiving antenna configured to receive GNSS direct signals at respective frequencies corresponding to at least two different GNSS systems;

a second receiving antenna configured to receive GNSS reflected signals at respective frequencies corresponding to at least two different GNSS systems;

an intermediate frequency signal acquisition device configured to acquire digital intermediate frequency signals of the GNSS direct signals and digital intermediate frequency signals of the GNSS reflected signals respectively, wherein the intermediate frequency signal acquisition device acquires the digital intermediate frequency signals of the GNSS direct signals received at respective frequencies corresponding to different GNSS systems through independent channels respectively, and acquires the digital intermediate frequency signals of the GNSS reflected signals received at respective frequencies corresponding to different GNSS systems through independent channels respectively; and

a data processing device configured to select the GNSS direct signal and the GNSS reflected signal of a corresponding frequency according to a detected strength of the intermediate frequency signals at respective frequencies corresponding to different GNSS systems or a predetermined setting, obtain a multipath Doppler frequency shift and a multipath time delay of the GNSS reflected signal with respect to the GNSS direct signal according to the digital intermediate frequency signal of the selected GNSS direct signal and the digital intermediate frequency signal of the selected GNSS reflected signal and further obtain earth surface parameters through inversion.

In one embodiment, the first receiving antenna is a left-handed directional antenna, and the second receiving antenna is a right-handed oriented antenna.

In one embodiment, the first receiving antenna and the second receiving antenna are phased array antennas which obtain a beam direction in which the received signal has the strongest strength through scanning for the receiving of GNSS signals.

In one embodiment, the first receiving antenna and the second receiving antenna comprise:

multiple antenna units arranged in an array, wherein each of the antenna units comprises: a substrate; a radiation pattern formed on a first surface of the substrate, including four sub-patterns that forms a rectangular shape; and a feed pattern formed on a second surface of the substrate;

a low-noise amplifier connected to the feed pattern of the antenna unit;

wherein each of the sub-patterns comprises a first part, a second part and a third part communicated with each other, the first part is communicated with the second part and the second part is communicated with the third part, the first part and the third part are symmetrically disposed with respect to the second part and have an identical rectangular shape, an end portion of the third part of each sub-pattern is disposed opposite to a side portion of the first part of a next adjacent sub-pattern so that the four sub-patterns form a rectangular shape, and the four sub-patters are not communicated with each other.

In one embodiment, the different GNSS systems comprise at least two of a global satellite positioning system, a BeiDou system, a Galileo system, and a GLONASS system.

In one embodiment, the data processing device is configured to obtain a Doppler frequency shift and a time delay of the GNSS direct signal according to the digital intermediate frequency signal of the GNSS direct signal, use the Doppler frequency shift and the time delay of the GNSS direct signal as native code of the GNSS reflected signal, and obtain the multipath Doppler frequency shift and the multipath time delay of the GNSS reflected signal with respect to the GNSS direct signal according to the digital intermediate frequency signal of the GNSS reflected signal.

In a second aspect, the present disclosure provides a GNSS-R earth surface survey method comprising:

receiving GNSS direct signals and GNSS reflected signals at respective frequencies corresponding to at least two different GNSS systems;

acquiring digital intermediate frequency signals of the GNSS direct signals and digital intermediate frequency signals of the GNSS reflected signals respectively, wherein the digital intermediate frequency signals of the GNSS direct signals received at respective frequencies corresponding to different systems are acquired through independent channels and the digital intermediate frequency signals of the GNSS reflected signals received at respective frequencies corresponding to different systems are acquired through independent channels;

selecting the GNSS direct signal and the GNSS reflected signal of a corresponding frequency according to a detected strength of the intermediate frequency signals at respective frequencies corresponding to different GNSS systems or a predetermined setting,

obtaining a multipath Doppler frequency shift and a multipath time delay of the GNSS reflected signal with respect to the GNSS direct signal according to the digital intermediate frequency signal of the selected GNSS direct signal and the digital intermediate frequency signal of the selected GNSS reflected signal; and

obtaining earth surface parameters through inversion according to the multipath Doppler frequency shift and the multipath time delay of the GNSS reflected signal with respect to the GNSS direct signal.

In one embodiment, the GNSS direct signal is received by a left-handed directional antenna, and the GNSS reflected signal is received by a right-handed directional antenna.

In one embodiment, receiving GNSS direct signals and GNSS reflected signals at respective frequencies corresponding to at least two different GNSS systems comprises:

obtaining a beam direction in which the received signal has the strongest strength by a phased array antenna for the receiving of the GNSS direct signals and the GNSS reflected signals.

In one embodiment, obtaining a multipath Doppler frequency shift and a multipath time delay of the GNSS reflected signal with respect to the GNSS direct signal according to the digital intermediate frequency signal of the selected GNSS direct signal and the digital intermediate frequency signal of the selected GNSS reflected signal comprises:

obtaining a Doppler frequency shift and a time delay of the GNSS direct signal according to the digital intermediate frequency signal of the GNSS direct signal; and

using the Doppler frequency shift and the time delay of the GNSS direct signal as native code of the GNSS reflected signal, and obtaining the multipath Doppler frequency shift and the multipath time delay of the GNSS reflected signal with respect to the GNSS direct signal according to the digital intermediate frequency signal of the GNSS reflected signal.

By configuring a GNSS signal receiving antenna capable of receiving signals at respective frequencies corresponding to different GNSS systems, and at the same time, acquiring, during an intermediate frequency extraction stage and through independent channels, direct signals and reflected signals of respective different frequencies so as to obtain digital intermediate frequency signals; selecting, based on a user setting or a signal strength, a GNSS system to be used to process data; and obtaining, by analyzing a Doppler frequency shift and a time delay of the digital intermediate frequency signal, a difference of the GNSS reflected signal with respect to the GNSS direct signal, thereby obtaining earth surface data through inversion on the basis of the same. In this way, the present disclosure enables compatibility with different GNSS system signals at the same time for earth surface survey.

### BRIEF DESCRIPTION OF THE DRAWINGS

The above and other objectives, features, and advantages of the present disclosure will become much clearer through following description of the embodiments of the present disclosure with reference to the accompanying drawings, wherein:

FIG. 1 is a schematic diagram of a principle of GNSS-R earth surface survey according to an embodiment of the present disclosure;

FIG. 2 is a schematic diagram of a GNSS-R earth surface survey device according to an embodiment of the present disclosure;

FIG. 3 is a schematic diagram of a preferred receiving antenna according to an embodiment of the present disclosure;

FIG. 4 is a schematic diagram of an antenna unit of the antenna shown in FIG. 3;

FIG. 5 is a schematic diagram of a human-machine interaction interface of a data processing device according to an embodiment of the present disclosure;

FIG. 6 is a Doppler frequency shift-time delay diagram obtained by the GNSS-R earth surface survey device according to the embodiment of the present disclosure; and

FIG. 7 is a flowchart of a GNSS-R earth surface survey method according to an embodiment of the present disclosure.

### PREFERRED EMBODIMENTS OF THE PRESENT INVENTION

The present disclosure will be described below based on the embodiments. However, the present disclosure is not limited to these embodiments. In the detailed description of the present disclosure hereinafter, some specific details will be described exhaustively. For those skilled in the art, the present disclosure may be thoroughly understood without description of these details. In order to avoid confusing the substance of the present disclosure, known methods, processes, flows, elements and circuits will not be described in detail.

In addition, a person of normal skill in the art should understand the drawings provided here are for illustrative purposes, and the drawings are not necessarily drawn in proportion.

Unless explicitly required in the context, the terms “comprise” and “include” and like expressions in the entire description and claims should be interpreted as an inclusive meaning, not an exclusive or exhaustive meaning; in other words, they mean “include, but not limited to.”

In the description of the present disclosure, it should be understood that the terms “first” and “second” are only for descriptive purposes, and cannot be understood as indicating or implying relative importance. In addition, in the description of the present disclosure, unless otherwise indicated, the meaning of “plural” is two or above.

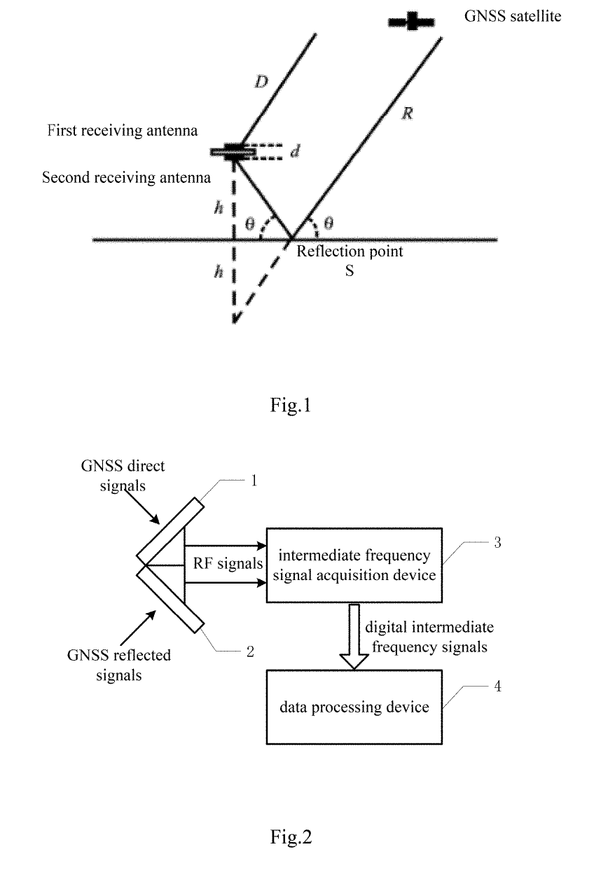

FIG. 1 is a schematic diagram of a principle of GNSS-R earth surface survey according to an embodiment of the present disclosure.

As shown in FIG. 1, the GNSS-R survey device disposed above the ground or water surface comprises a first antenna for receiving a GNSS direct signal and a second antenna for receiving a GNSS reflected signal. According to the principle of space geometry, without considering the unfavorable factors for space propagation such as atmosphere, the minimal propagation path difference between a mirror reflection and a direct signal is:

R−D=(2h+d)·sin θ (1)

Wherein h is a height of the first receiving antenna to the reflecting surface (i.e., ground or water surface); θ is a pitch angle of the reflecting point to a certain satellite; d is a distance between phase centers of two antennas of the GNSS-R survey device; D is a geometric distance of the GNSS direct signal between the satellite and the first receive antenna; and R is a geometric length of the signal path of the reflected signal received by the second receiving antenna.

After accurately measuring a propagation geometric path difference d_{dif}=R−D between the direct signal and the reflected signal, a vertical height h of the observed reflecting surface to the reflecting antenna of the receiving platform is obtained as:

$$h = \frac{1}{2} ( \frac{{d}_{dif}}{sin θ} - d ) \qquad ( 2 )$$

d_{dif} can be calculated by measuring a time difference between the propagation time of a signal transmitted by a satellite reaching a receiver through a direct path and a reflected path respectively. With respect to a relatively calm lake or sea surface, when the effective wave height ratio of the reflecting surface is relatively small, the coherence of the reflected signal is maintained, and the propagation time difference between the direct path and the reflected path is obtained by measuring carrier phase states which reconstruct the direct signal and reflected signal. The tracking precision of a ground receiver to the carrier phase of a direct signal under a conventional GPS signal receiving strength can generally reach 0.01 cycles.

A carrier phase observation refers to a carrier phase (or measure-phase pseudorange) extracted at a certain time interval when the receiver reaches the carrier phase tracking state, which is applied to the position calculation for the carrier phase. The carrier phase observation for one certain satellite is composed of three parts: an initial integer ambiguity N₀, an integer count C(n) from the beginning of locking to time n and a phase mantissa φ(n). In the altimetry application, the carrier phase observation φdir(n)=Cd(n)+φd(n) (with initial integer ambiguity) of the direct signal and the carrier phase observation φref(n)=Cr(n)+φr(n) (with initial integer ambiguity) of the reflected signal at the nth epoch are actually extracted, the integer ambiguity thereof are N₀ᵣ and N_{0d} respectively.

Considering the situation of one satellite and one receiver, at this time, the pseudorange observation equations for the direct signal and the reflected signal are:

λ_{Lφdir}(n)=[D(n)+Dₜᵣₒ(n)+Dᵢₒₙ(n)]+cδ_{uclock}(n)−cδ_{dsclock}(n)−λ_{L}N_{0d}+λ_{L}εφ_{d}(n) (3)

λ_{Lφref}(n)=[R(n)+Rₜᵣₒ(n)+Rᵢₒₙ(n)]+cδ_{uclock}(n)−cδ_{rsclock}(n)−λ_{L}N₀ᵣ+λ_{L}εφᵣ(n) (4)

wherein,

x(n) is an observation for a physical quantity x at the nth epoch;

φdir is a carrier phase observation for the direct signal;

Dₜᵣₒ is an error in propagation distance caused by tropospheric refraction on the propagation of the direct signal;

Dᵢₒₙ is an error in propagation distance caused by ionospheric refraction on the propagation of the direct signal;

δ_{uclock} is a clock error of the user;

δ_{dsclock} is a satellite clock error corresponding to the direct signal;

εφ_{d} is a comprehensive error caused by phase noise of the satellite clock and

receiver clock, receiver hardware phase delay, cycle skip, etc. on the carrier measurement of the direct signal, in cycles;

φref is a carrier phase observation for the reflected signal;

Rₜᵣₒ is an error in propagation distance caused by tropospheric refraction on the propagation of the reflected signal;

Rᵢₒₙ is an error in propagation distance caused by ionospheric refraction on the propagation of the reflected signal;

δ_{rsclock} is a satellite clock error corresponding to the relected signal;

εφᵣ is a comprehensive error caused by phase noise of the satellite clock and receiver clock, receiver hardware phase delay, cycle skip, etc. on the carrier measurement of the relected signal, in cycles.

The difference of the initial pseudorange observation equations for the direct signal and the reflected signal of the same satellite is calculated as:

λ_{L}[φ_{ref}(n)−φ_{dir}(n)]=R(n)−D(n)+Rₜᵣₒ(n)−Dₜᵣₒ(n)+λ_{L}[εφᵣ(n)−εφ_{d}(n)]−c[δ_{rsclock}(n)−δ_{dsclock}(n)]−λ_{L[}ΔN₀ᵣ−ΔN_{0d}] (5)

By calculating the difference, the time synchronized clock error of the user is basically eliminated. Since the satellite clock errors corresponding to the direct signal and the reflected signal observed at epoch n are not completely synchronized, calculating difference via δ_{rsclock}(n)−δ_{dsclock}(n) only weakens the influence of the satellite clock error on a long-term stability and can not eliminate the impact of short-term stability.

With respect to the error caused by the troposphere on the propagation distance, since the propagation paths through which the direct signal and the reflected signal travel are close to each other (<20 km) and the troposphere has similar physical properties at positions that are close in distance, calculating the difference between approximate synchronized observations for the same satellite significantly weakens the influence of the tropospheric refraction. However, since the value of the refractive index of the troposphere close to the lake surface is maximal among those of the troposphere, considering that the propagation paths of the direct signal and the reflected signal at the position close to the lake surface are different, the influence of the troposphere is not completely eliminated, especially when the propagation distances of the direct signal and the reflected signal differ considerably.

The ionosphere also has similar physical properties at positions that are close in space. By calculating the difference between the approximate synchronized observations of the direct signal and reflected signal observed for the same satellite, the error of the ionosphere is significantly weakened. Since the randomness of εφᵣ(n) and εφ_{d}(n) are both relatively strong and the correlation therebetween is weak, it can be considered that they are not weakened by calculating the difference.

Equation (5) is simplified as:

λ_{L}Δφ(n)=d_{dif}(n)+ΔE+λ_{L}Δεφ(n)−cΔδ_{sclock}(n)−λ_{L}ΔN (6)

wherein, Δφ(n)=φ_{ref}(n)−φ_{dir}(n) is the difference between the measure-phase pseudorange of the direct signal and the measure-phase pseudorange of the reflected signal, ΔN₀=N₀ᵣ−N_{0d} is the difference between the integer ambiguity of the direct signal and the integer ambiguity of the reflected signal, d_{dif}(n)=R(n)−D(n) is the difference between the propagation distance of the direct signal and the propagation distance of the reflected signals in the geometric space, ΔE=Rₜᵣₒ(n)−Dₜᵣₒ(n) is the influence of the troposphere on signal propagation due to different propagation paths of the direct signal and reflected signal and the value thereof can be approximately calculated. Δδ_{sclock}(n)=δ_{rsclock}(n)−δ_{dsclock} is a difference of the satellite clock corresponding to the direct signal and the reflected signal and Δεφ(n)=εφᵣ(n)−εφ_{d}(n) is the difference between random observation errors of the direct signal and the reflected signal.

For the single-difference observation as described above, the difference between epochs is further calculated. After calculating the difference, the satellite clock error is basically eliminated and the integer ambiguity is eliminated, and the following equation is obtained:

λ_{L}Δφ(n₁,n₂)=d_{dif}(n₁,n₂)+λ_{L}Δεφ(n₁,n₂) (7)

wherein

Δφ(n₁,n₂)=Δφ(n₂)−Δφ(n₁) (8a)

d_{dif}(n₁,n₂)=d_{dif}(n₂)−d_{dif}(n₁) (8b)

Δεφ(n₁,n₂)=Δεφ(n₂)−Δεφ(n₂) (8c)

Bring formula (1) into formula (8a) to obtain the following equation:

d_{dif}(n₁,n₂)=2h(n₂)sin θ(n₂)−2h(n₁)sin θ(n₁)+d[sin θ(n₂)−sin θ(n₁)] (9)

The elevation angle is calculated by determining the location of the receiver by using the direct signal. Since the elevation angle can only produce a slight variation in a short time (0.1 second), when n₂T−n₁T<0.1s (T represents a time interval between adjacent epochs), it can be assumed that sin θ(n₂)≈sin θ(n₁), and d is known and determined. Equation (9) can be approximated as:

d_{dif}(n₁,n₂)=2hd_{dif}(n₁,n₂)sin θ(n₁) (10)

wherein, h d_{dif}(n₁,n₂)=h(n₂)−h(n₁)ₒ

The estimated lake surface height change between epochs obtained by equations (7) and (10) is:

$$\hat{h} ( {n}_{1} , {n}_{2} ) = \frac{{λ}_{L} Δ φ ( {n}_{1} , {n}_{2} )}{2 sin θ {n}_{1}} \qquad ( 11 )$$

It can be seen that the lake surface height calculated from the carrier phase observations obtained at epochs n₁,n₂ changes between the epochs n1,n2,.

The superscript is used to represent the lake surface height ĥⁱ(n₁,n₂), ĥ^{j}(n₁,n₂), . . . between epochs estimated from the observations of satellites i,j, . . . . An averaged height change trajectory h̅(n₁, n₂), h̅(n₂, n₃), . . . , h̅(nₙ₋₁, nₙ) is obtained by performing a weighted average on the estimated height change values obtained from the observations of different satellites within a period of time (such as between epoch interval [n₁,n_{N}]) according to estimation quality (determined by the noise-signal ratio of the signal and so on). The reliability and precision of the system is improved by using the redundancy of the information.

Through the process of calculating the differences in the above method, the influences caused by ionosphere, troposphere, satellite clock error, satellite ephemeris, receiver clock error and so on are basically eliminated, and an estimated height change value influenced by smaller residual random errors is obtained.

Based on the above principle, the earth surface parameters can be obtained without the need of decoding the GNSS signal.

FIG. 2 is a schematic diagram of a GNSS-R earth surface survey device according to an embodiment of the present disclosure. As shown in FIG. 2, the GNSS-R earth surface survey device comprises a first receiving antenna 1, a second receiving antenna 2, an intermediate frequency signal acquisition device 3 and a data processing device 4. The first receiving antenna 1 and the second receiving antenna 2 are respectively connected to the intermediate frequency signal acquisition device 3 through radio frequency cables. The intermediate frequency signal acquisition device 3 is connected to the data processing device 4 via a serial port or other digital signal transmission interface.

Wherein, the first receiving antenna 1 is configured to receive GNSS direct signals at respective frequencies corresponding to at least two different GNSS systems.

The second receiving antenna 2 is configured to receive GNSS reflected signals at respective frequencies corresponding to at least two different GNSS systems.

The first receiving antenna 1 and the second receiving antenna 2 can be both directional antennas and omnidirectional antennas.

In one embodiment, the first receiving antenna 1 is a left-handed directional antenna and can directionally receive a left-handed circularly polarized GNSS direct signal. At the same time, the second receiving antenna 2 is a right-handed directional antenna and can directionally receive a right-handed circularly polarized GNSS reflected signal. The advantage of using directional antennas is that, after adjusting to a better receiving direction, the directional antennas can receive the GNSS direct signals and the reflected signals with a higher gain, and at the same time, the pitch angles thereof are relatively definite, and subsequent time delay acquisition can be performed better.

In one embodiment, the first receiving antenna 1 and the second receiving antenna 2 can be phased array antennas. By adjusting the directivity of the phased array antenna to scan the signals received at different directions, the beam direction in which the received signal has the strongest strength can be obtained and is determined as the direction for receiving the GNSS signal to obtain the best signal receiving effect.

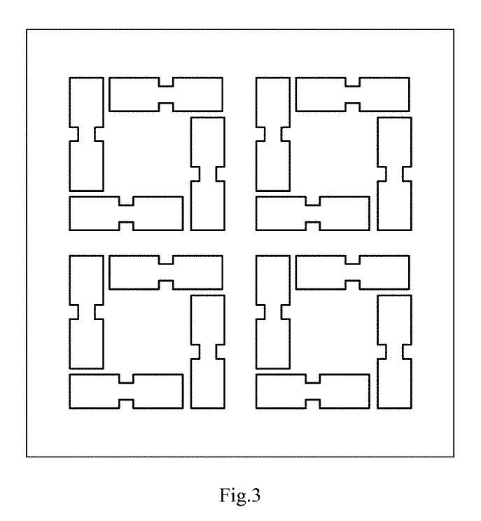

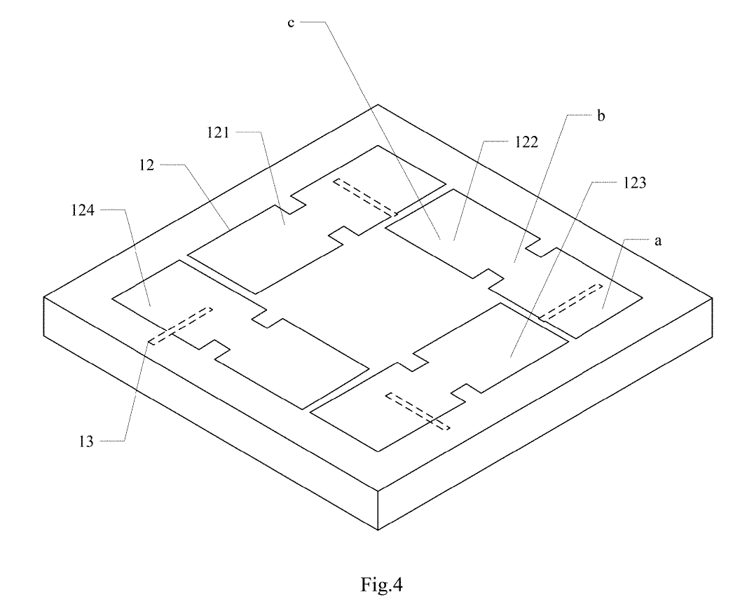

FIG. 3 is a schematic diagram of a preferred receiving antenna according to an embodiment of the present disclosure and FIG. 4 is a schematic diagram of an antenna unit of the antenna shown in FIG. 3. The antenna as shown in FIG. 3 can receive both a right-handed circularly polarized signal and a left-handed circularly polarized signal. The preferred receiving antenna comprises four antenna units and a low-noise amplifier. Each of the antenna units comprises a substrate 11, a radiation pattern 12, and a feed pattern 13. The radiation pattern 12 is formed on a first surface of the substrate 11, including four sub-patterns 121, 122, 123, and 124 that form a rectangular shape.

Wherein, each of the sub-patterns comprises a first part a, a second part b and a third part c communicated with each other. The first part a is communicated with the second part b and the second part b is communicated with the third part c. The first part a and the third part c are symmetrically disposed with respect to the second part b and have an identical rectangular shape. The axes of the first part a, the second part b and the third part c are arranged in a line. In the present embodiment, the second part b is also formed to have a rectangular shape with a width less than that of the first part a and the third part c, so that the sub-patterns 121-124 are respectively formed to be dumbbell-like patterns composed of rectangles. In the present embodiment, the sub-patterns 121-124 are hollowed out patterns formed on a conductive material layer. The conductive material may be a metal conductive material such as gold, silver or copper, or may be an oxide conductive material such as ITO.

The four sub-patterns 121-124 form a rectangle in a circular manner in their mutual position arrangement. Specifically, an end portion of a side of one sub-pattern is disposed opposite to a portion of a side of a next adjacent sub-pattern that is close to the end of the side.

More specifically, an end portion of the third part c of each sub-pattern is disposed opposite to a side portion of the first part a of the next adjacent sub-pattern so that the four sub-patterns form a rectangular shape and the four sub-patterns are not communicated with each other.

The thus-formed antenna unit can receive both a right-handed circularly polarized signal and a left-handed circularly polarized signal.

At the same time, the feed pattern 13 is disposed on a second surface of the substrate 11 opposite to the first surface thereof and at least comprises a conductive pattern located at a position corresponding to the first part a of each sub-pattern

The low-noise amplifier 2 is electrically connected to the feed pattern 13, receives a GNSS electromagnetic signal received via the radiation pattern, amplifies the received signal and transmits the amplified signal to a signal processing system connected to the GNSS receiving antenna. In one embodiment, the low-noise amplifier 2 can be a low-noise amplifier using an SMA interface. The low-noise amplifier 2 can be mounted on a side of one of the support members 3 to draw out signals received by the antenna units.

Thus, both the first receiving antenna capable of receiving the right-handed circularly polarized signal and the second receiving antenna capable of receiving the left-handed circularly polarized signal can be formed by the antenna with the same structure. At the same time, the antenna with the above structure can simultaneously receive signals at multiple different frequencies so as to receive the GNSS direct signals or the GNSS reflected signals at respective frequencies corresponding to at least two different GNSS systems.

In the present embodiment, the first receiving antenna 1 and the second receiving antenna 2 can simultaneously receive the GNSS signals at a frequency point L of the GPS system and frequency points B1, B2 and B3 of the BeiDou system. It should be understood that the present disclosure can also be applied to receiving, acquiring, and processing signals based on at least two systems among a GPS system, a BeiDou system, a Galileo system, and a GLONASS system.

The intermediate frequency signal acquisition device 3 is configured to acquire the digital intermediate frequency signal of the GNSS direct signal and the digital intermediate frequency signal of the GNSS reflected signal, wherein the intermediate frequency signal acquisition device acquires the digital intermediate frequency signals of the GNSS direct signals received at respective frequencies corresponding to different GNSS systems through independent channels respectively, and acquires the digital intermediate frequency signals of the GNSS reflected signals received at respective frequencies corresponding to different GNSS systems through independent channels respectively.

The intermediate frequency signal acquisition device 3 of the present embodiment of the present disclosure can work in the following frequency bands.

GPS L1 frequency band: 1575.42 MHz±0.05 MH;

BD2 B1 frequency band: 1561.098 MHz±0.05 MH;

BD2 B2 frequency band: 1207.14 MHz±0.05 MH;

BD2 B3 frequency band: 1268.52 MHz±0.05 MHz;

GLONASS frequency band: 1602±0.05 MHz

Specifically, the intermediate frequency signal acquisition device of the present embodiment acquires the digital intermediate frequency signals of the direct signal and reflected signal of the GPS system and the digital intermediate frequency signals of the direct signal and reflected signal of the BeiDou system through four independent channels. Therefore, under the premise that Interface Control Document (ICD) in BeiDou system is not involved, Beidou-plus-GPS dual-mode unified intermediate frequency signal acquisition and processing are realized.

The data processing device 4 is configured to select the GNSS direct signal and the GNSS reflected signal of a corresponding frequency according to a detected strength of the intermediate frequency signals at respective frequencies corresponding to different GNSS systems or a predetermined setting, obtain a multipath Doppler frequency shift and a multipath time delay of the GNSS reflected signal with respect to the GNSS direct signal according to the digital intermediate frequency signal of the selected GNSS direct signal and the digital intermediate frequency signal of the selected GNSS reflected signal and further obtain earth surface parameters through inversion.

Therefore, the data processing device 4 can use the GNSSS signal with the highest quality to perform earth surface survey, but can also perform the earth surface survey according to a selection of the user.

Specifically, the data processing device 4 is configured to obtain a Doppler frequency shift and a time delay of the GNSS direct signal according to the digital intermediate frequency signal of the GNSS direct signal, use the Doppler frequency shift and the time delay of the GNSS direct signal as native code of the GNSS reflected signal, and obtain the multipath Doppler frequency shift and the multipath time delay of the GNSS reflected signal with respect to the GNSS direct signal according to the digital intermediate frequency signal of the GNSS reflected signal. The data processing device 4 can be implemented by a general-purpose computer system carrying a data processing program, that is, the determination of the multipath Doppler frequency shift and the multipath time delay of the GNSS reflected signal with respect to the GNSS direct signal is implemented by the way of executing program instructions through the general-purpose computer system.

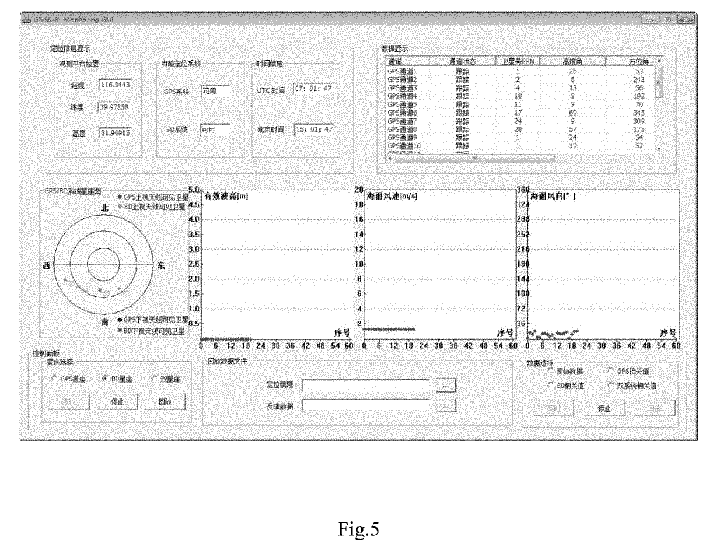

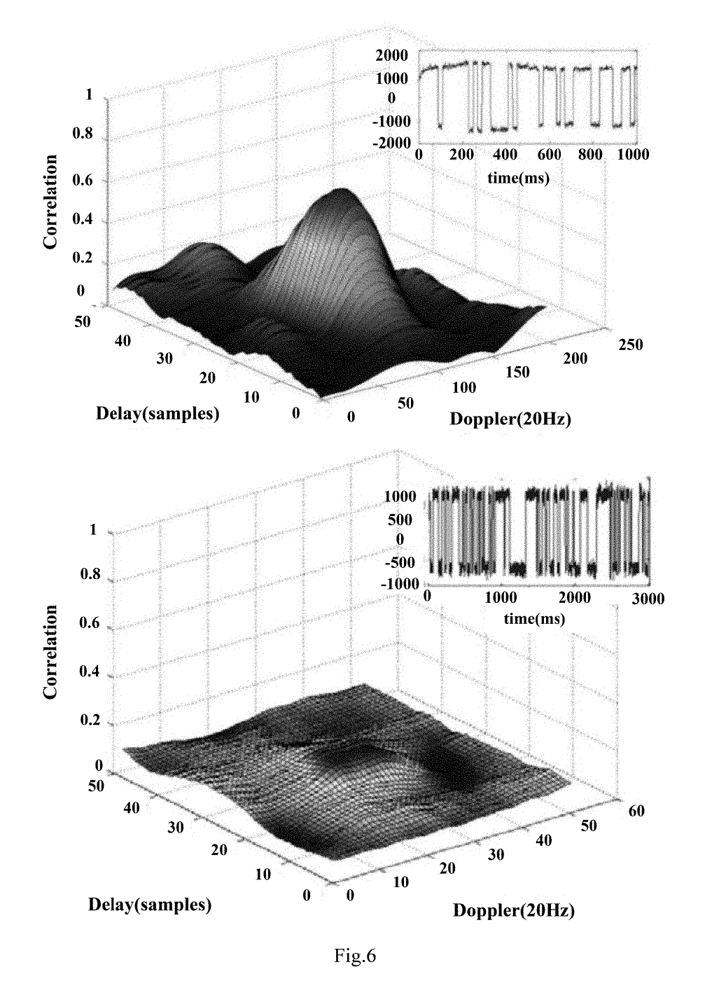

FIG. 5 is a schematic diagram of a human-machine interaction interface of a data processing device according to an embodiment of the present disclosure and FIG. 6 is a Doppler frequency shift-time delay diagram obtained by the GNSS-R earth survey device according to the embodiment of the present disclosure. As shown in FIGS. 5-6, the human-computer interaction interface of the data processing device of the present disclosure can display a current position, different signal strengths and earth surface parameters (for example, wave height, wind speed, wind direction, etc. of the sea surface) obtained from the inversion of the acquired signals. The inversion based on time delay and Doppler frequency shift maps can be performed by using various existing earth surface parameter inversion methods.

Since the embodiments of the present disclosure adopt the way of carrier phase detection to obtain the difference between the GNSS reflected signal and the GNSS direct signal, decoding is thus not required. Therefore, the receiving, intermediate frequency acquiring and processing of the carrier signals can be compatible with different GNSS systems. At the same time, using an array antenna formed by antenna units that can receive both a right-handed circularly polarized signal and a left-handed circularly polarized signal to directionally receive the GNSS signal, the quality of the signal is improved and the structure of the system is simplified. Furthermore, the signal with the best quality can be selected for inversion according to the signals of different GNSS systems so as to improve the accuracy of GNSS-R earth surface survey.

By configuring a GNSS signal receiving antenna capable of receiving signals at respective frequencies corresponding to different GNSS systems, and at the same time, acquiring, during an intermediate frequency extraction stage and through independent channels, direct signals and reflected signals of respective different frequencies so as to obtain digital intermediate frequency signals; selecting, based on a user setting or a signal strength, a GNSS system to be used to process data; and obtaining, by analyzing a Doppler frequency shift and a time delay of the digital intermediate frequency signal, a difference of the GNSS reflected signal with respect to the GNSS direct signal, thereby obtaining earth surface data through inversion on the basis of the same. In this way, the present disclosure enables compatibility with different GNSS system signals at the same time for earth surface survey.

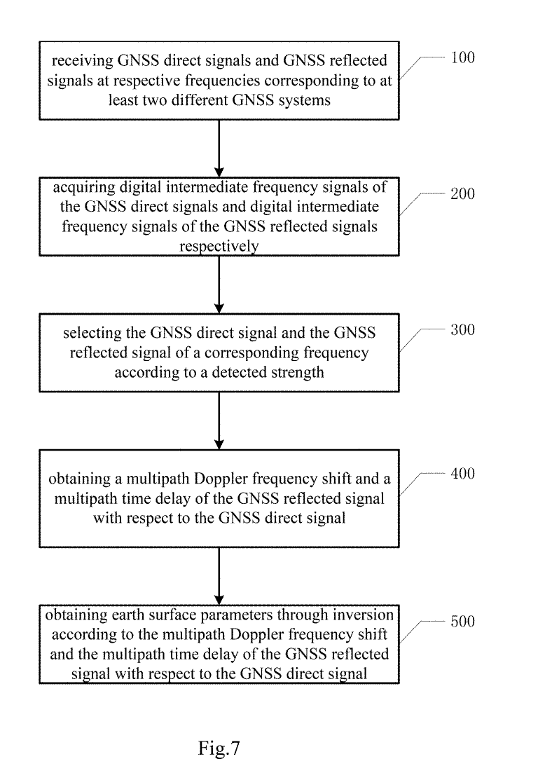

FIG. 7 is a flowchart of a GNSS-R earth surface survey method according to an embodiment of the present disclosure.

As shown in FIG. 7, the GNSS-R earth surface survey method comprises the following steps:

Step 100: receiving GNSS direct signals and GNSS reflected signals at respective frequencies corresponding to at least two different GNSS systems.

In one embodiment, the GNSS direct signal is received by a left-handed directional antenna, and the GNSS reflected signal is received by a right-handed directional antenna.

In one embodiment, step 100 comprises:

obtaining a beam direction in which the received signal has the strongest strength by a phased array antenna for the receiving of the GNSS direct signals and the GNSS reflected signals.

Step 200: acquiring digital intermediate frequency signals of the GNSS direct signals and digital intermediate frequency signals of the GNSS reflected signals respectively, wherein the digital intermediate frequency signals of the GNSS direct signals received at respective frequencies corresponding to different systems are acquired through independent channels and the digital intermediate frequency signals of the GNSS reflected signals received at respective frequencies corresponding to different systems are acquired through independent channels.

Step 300: selecting the GNSS direct signal and the GNSS reflected signal of a corresponding frequency according to a detected strength of the intermediate frequency signals at respective frequencies corresponding to different GNSS systems or a predetermined setting.

Step 400: obtaining a multipath Doppler frequency shift and a multipath time delay of the GNSS reflected signal with respect to the GNSS direct signal according to the digital intermediate frequency signal of the selected GNSS direct signal and the digital intermediate frequency signal of the selected GNSS reflected signal.

Wherein step 400 can comprise:

Step 410: obtaining a Doppler frequency shift and a time delay of the GNSS direct signal according to the digital intermediate frequency signal of the GNSS direct signal.

Step 420: using the Doppler frequency shift and the time delay of the GNSS direct signal as native code of the GNSS reflected signal, and obtaining the multipath Doppler frequency shift and the multipath time delay of the GNSS reflected signal with respect to the GNSS direct signal according to the digital intermediate frequency signal of the GNSS reflected signal.

Step 500: obtaining earth surface parameters through inversion according to the multipath Doppler frequency shift and the multipath time delay of the GNSS reflected signal with respect to the GNSS direct signal.

By configuring a GNSS signal receiving antenna capable of receiving signals at respective frequencies corresponding to different GNSS systems, and at the same time, acquiring, during an intermediate frequency extraction stage and through independent channels, direct signals and reflected signals of respective different frequencies so as to obtain digital intermediate frequency signals; selecting, based on a user setting or a signal strength, a GNSS system to be used to process data; and obtaining, by analyzing a Doppler frequency shift and a time delay of the digital intermediate frequency signal, a difference of the GNSS reflected signal with respect to the GNSS direct signal, thereby obtaining earth surface data through inversion on the basis of the same. In this way, the present disclosure enables compatibility with different GNSS system signals at the same time for earth surface survey.

What are described above are only preferred embodiments of the present disclosure, which are not intended to limit the present invention. To those skilled in the art, the present invention may have various alternations and changes. Any modifications, equivalent replacements, and improvements made within the spirit and principle of the present invention should be included within the protection scope of the present disclosure.

What is claimed is:

1. A GNSS-R earth surface survey device comprising:
a first receiving antenna configured to receive GNSS direct signals at respective frequencies corresponding to at least two different GNSS systems;
a second receiving antenna configured to receive GNSS reflected signals at respective frequencies corresponding to at least two different GNSS systems;
an intermediate frequency signal acquisition device configured to acquire digital intermediate frequency signals of the GNSS direct signals and digital intermediate frequency signals of the GNSS reflected signals respectively, wherein the intermediate frequency signal acquisition device acquires the digital intermediate frequency signals of the GNSS direct signals received at respective frequencies corresponding to different GNSS systems through independent channels respectively, and acquires the digital intermediate frequency signals of the GNSS reflected signals received at respective frequencies corresponding to different GNSS systems through independent channels respectively; and
a data processing device configured to select the GNSS direct signal and the GNSS reflected signal of a corresponding frequency according to a detected strength of the intermediate frequency signals at respective frequencies corresponding to different GNSS systems or a predetermined setting, obtain a multipath Doppler frequency shift and a multipath time delay of the GNSS reflected signal with respect to the GNSS direct signal according to the digital intermediate frequency signal of the selected GNSS direct signal and the digital intermediate frequency signal of the selected GNSS reflected signal and further obtain earth surface parameters through inversion.

2. The GNSS-R earth surface survey device of claim 1, wherein the first receiving antenna is a left-handed directional antenna, and the second receiving antenna is a right-handed oriented antenna.

3. The GNSS-R earth surface survey device of claim 2, wherein the first receiving antenna and the second receiving antenna are phased array antennas which obtain a beam direction in which the received signal has the strongest strength through scanning for the receiving of GNSS signals.

4. The GNSS-R earth surface survey device of claim 3, wherein the first receiving antenna and the second receiving antenna comprise:
multiple antenna units arranged in an array, wherein each of the antenna units comprises:
a substrate; a radiation pattern formed on a first surface of the substrate, including four sub-patterns that forms a rectangular shape; and a feed pattern formed on a second surface of the substrate;
a low-noise amplifier connected to the feed pattern of the antenna unit;
wherein each of the sub-patterns comprises a first part, a second part and a third part communicated with each other, the first part is communicated with the second part and the second part is communicated with the third part, the first part and the third part are symmetrically disposed with respect to the second part and have an identical rectangular shape, an end portion of the third part of each sub-pattern is disposed opposite to a side portion of the first part of a next adjacent sub-pattern so that the four sub-patterns form a rectangular shape, and the four sub-patters are not communicated with each other.

5. The GNSS-R earth surface survey device of claim 1, wherein the different GNSS systems comprise at least two of a global satellite positioning system, a BeiDou system, a Galileo system, and a GLONASS system.

6. The GNSS-R earth surface survey device of claim 1, wherein the data processing device is configured to obtain a Doppler frequency shift and a time delay of the GNSS direct signal according to the digital intermediate frequency signal of the GNSS direct signal, use the Doppler frequency shift and the time delay of the GNSS direct signal as native code of the GNSS reflected signal, and obtain the multipath Doppler frequency shift and the multipath time delay of the GNSS reflected signal with respect to the GNSS direct signal according to the digital intermediate frequency signal of the GNSS reflected signal.

7. A GNSS-R earth surface survey method comprising:
receiving GNSS direct signals and GNSS reflected signals at respective frequencies corresponding to at least two different GNSS systems;
acquiring digital intermediate frequency signals of the GNSS direct signals and digital intermediate frequency signals of the GNSS reflected signals respectively, wherein the digital intermediate frequency signals of the GNSS direct signals received at respective frequencies corresponding to different systems are acquired through independent channels and the digital intermediate frequency signals of the GNSS reflected signals received at respective frequencies corresponding to different systems are acquired through independent channels;
selecting the GNSS direct signal and the GNSS reflected signal of a corresponding frequency according to a detected strength of the intermediate frequency signals at respective frequencies corresponding to different GNSS systems or a predetermined setting, obtaining a multipath Doppler frequency shift and a multipath time delay of the GNSS reflected signal with respect to the GNSS direct signal according to the digital intermediate frequency signal of the selected GNSS direct signal and the digital intermediate frequency signal of the selected GNSS reflected signal; and
obtaining earth surface parameters through inversion according to the multipath Doppler frequency shift and the multipath time delay of the GNSS reflected signal with respect to the GNSS direct signal.

8. The GNSS-R earth surface survey method of claim 7, wherein the GNSS direct signal is received by a left-handed directional antenna, and the GNSS reflected signal is received by a right-handed directional antenna.

9. The GNSS-R earth surface survey method of claim 7, wherein receiving GNSS direct signals and GNSS reflected signals at respective frequencies corresponding to at least two different GNSS systems comprising:
obtaining a beam direction in which the received signal has the strongest strength by a phased array antenna for the receiving of the GNSS direct signals and the GNSS reflected signals.

10. The GNSS-R earth surface survey method of claim 7, wherein obtaining a multipath Doppler frequency shift and a multipath time delay of the GNSS reflected signal with respect to the GNSS direct signal according to the digital intermediate frequency signal of the selected GNSS direct signal and the digital intermediate frequency signal of the selected GNSS reflected signal comprising:
obtaining a Doppler frequency shift and a time delay of the GNSS direct signal according to the digital intermediate frequency signal of the GNSS direct signal; and
using the Doppler frequency shift and the time delay of the GNSS direct signal as native code of the GNSS reflected signal, and obtaining the multipath Doppler frequency shift and the multipath time delay of the GNSS reflected signal with respect to the GNSS direct signal according to the digital intermediate frequency signal of the GNSS reflected signal.
